(19) United States
(12) Patent Application Publication
(10) Pub. No.: US 2016/0283541 A1
(43) Pub. Date: Sep. 29, 2016

(54) ENTERPRISE KNOWLEDGE AND REFERENCE DATA DRIVEN PERSISTENCE IN HYBRID MASTER DATA MANAGEMENT

(71) Applicant: International Business Machines Corporation, Armonk, NY (US)

(72) Inventors: Suchitra S. Iyer, Cedar Park, TX (US); Stephen J. Moore, Austin, TX (US); Sushain Pandit, Austin, TX (US); Yinle Zhou, Austin, TX (US)

(21) Appl. No.: 14/669,299

(22) Filed: Mar. 26, 2015

(51) Int. Cl. G06F 17/30

(52) U.S. Cl. CPC G06F 17/30371; G06F 17/303; G06F 17/30424

(57) ABSTRACT

A request to move a reference data set in a virtual MDM to a physical MDM is received. For the reference data set in the virtual MDM if there is an at least partially matching reference data set in the physical MDM is determined. The request received is performed, wherein the request is performed for the reference data set of the virtual MDM.

### BACKGROUND

The present invention relates generally to the field of master data management (MDM), and more particularly to persistence of data from a virtual implementation to a physical implementation in a MDM environment.

Typical MDM systems follow a few different implementation styles. In a virtual MDM implementation, data is managed such that it remains fragmented across the source systems in a distributed manner with a central indexing service. In a physical MDM implementation, master data is stored or created in a centralized system from where it is accessed. Additionally, there is a hybrid MDM implementation that includes both the virtual style and physical style.

In a hybrid MDM implementation, several capabilities are exposed that allow for seamless movement of master data entities between their virtual and physical representations. Master data entities often refer to code tables (i.e. reference data sets) through attribute values. Reference data is a special class of metadata which is used to categorize master data within an enterprise across multiple systems. Reference data is usually defined in the form of reference data sets, where such a data set is a collection of reference data values. Stewardship, authoring, and management of reference data allows for taking reference data sets through various lifecycle phases, creating versions of a base data set, creating mappings between different reference data representations to an enterprise-wide standard, publishing/distributing approved data sets, etc.

### SUMMARY

Embodiments of the present invention include a method, computer program product, and system for managing data persistence between a virtual master data management (MDM) system and a physical MDM system. In one embodiment, a request to move a reference data set in a virtual MDM to a physical MDM is received. For the reference data set in the virtual MDM if there is an at least partially matching reference data set in the physical MDM is determined. The request received is performed, wherein the request is performed for the reference data set of the virtual MDM.

### BRIEF DESCRIPTION OF THE DRAWINGS

FIG. 1 is a functional block diagram of a data processing environment, in accordance with an embodiment of the present invention;

FIG. 2 is a flowchart depicting operational steps for managing data persistence between a virtual MDM and a physical MDM, in accordance with an embodiment of the present invention; and

FIG. 3 depicts a block diagram of components of the computer and server of FIG. 1, in accordance with an embodiment of the present invention.

### DETAILED DESCRIPTION

Embodiments of the present invention provide a program for managing data persistence between a virtual MDM and a physical MDM. First, the program determines a MDM to manage (i.e., at least one virtual MDM and at least one physical MDM). The program will then receive a request for data persistence of data found in the virtual MDM to be moved to the physical MDM. The program will check the virtual MDM and link all reference data sets of the virtual MDM to reference data sets of the physical MDM. The program the modifies the linked reference data sets of the virtual MDM so that the data sets can be moved from the virtual MDM to the physical MDM. The data is then transferred and the program checks the physical MDM reference data for accuracy.

Embodiments of the present invention recognize that before the persistence of data from virtual MDM to physical MDM one or more of the following needs to happen: (i) attributes considered mandatory by the physical MDM must exist in the virtual MDM records; (ii) equivalent reference data must exist; (iii) reference data must be properly transcoded; and (iv) certain type code must be valid. Embodiments of the present invention recognize that current MDM implementations assume that all of these management steps are already taken care of. A team of data stewards would need to go through the laborious, error prone and time consuming task of performing each of these steps manually.

Reference data is any data that is used to categorize other data within an enterprise. Reference data is commonly stored in the form of code tables or lookup tables, such as country codes, state codes, and gender codes. Reference data is used within enterprise applications, from back-end systems through front-end commerce applications to the data warehouse. Business users recognize reference data as code choices within the pick-lists of their business application user interfaces. Reference data code tables are often implemented in the database as relatively simple structures with a key column that contains a code value and a description column. Some code tables, such as NACE (Nomenclature of Economic Activities), SIC (Standard Industry Classification), and NAICS (North American Industry Classification System), have few values (in the tens or hundreds). Others, such as healthcare ICD-10 (International Statistical Classification of Disease and Related Health Problems) codes, have larger numbers of values (in the tens of thousands). They can be flat lists or have a hierarchical code structure. A hierarchy can be defined over the values within the code table, or a hierarchy can be defined where each level is a code table in its own right.

The structural simplicity and static nature of code tables belies the cost and difficulty of managing code tables at the enterprise level. The problems with code tables include the sheer number of code tables that are used within and across enterprise applications. Each application often has its own representation and set of values for code sets defining the same thing. When you integrate data across applications, you must translate between the different code table representations to categorize data in a consistent way. Mapping between the different representations and tracking changes across all the different code table variations on an ongoing basis can be a major challenge. Many enterprises struggle with this challenge by using spreadsheets and other error-prone manual processes to record and manage changes to reference data sets and their relationships to each other. The lack of change management, audit controls, and security is often a compliance risk. Reference data is used to drive key business processes and application logic and therefore errors in the reference data can have a major business impact.

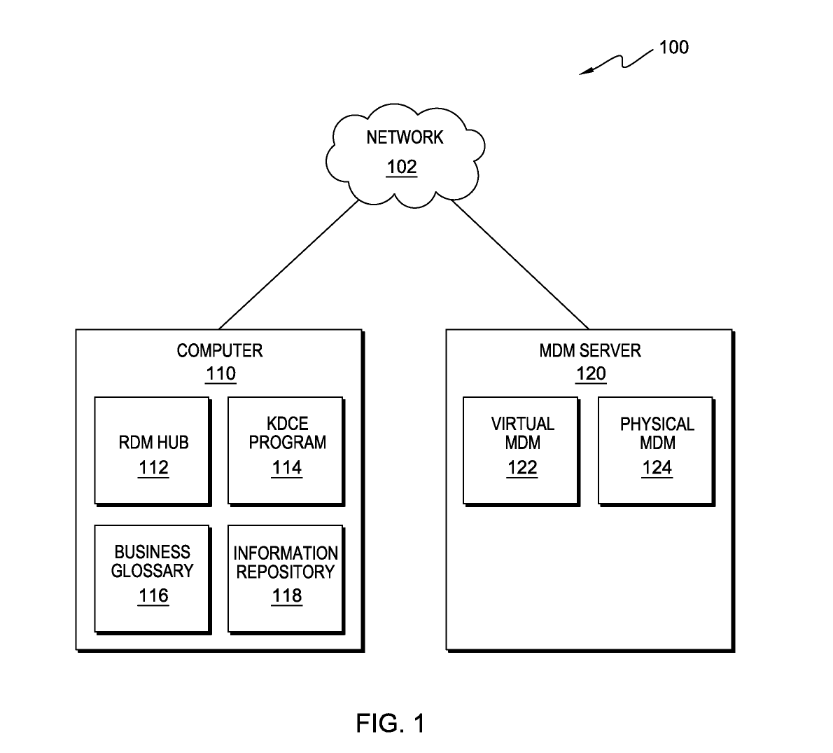

The present invention will now be described in detail with reference to the Figures. FIG. 1 is a functional block diagram illustrating a data processing environment, generally designated 100, in accordance with one embodiment of the present invention. FIG. 1 provides only an illustration of one implementation and does not imply any limitations with regard to the systems and environments in which different embodiments may be implemented. Many modifications to the depicted embodiment may be made by those skilled in the art without departing from the scope of the invention as recited by the claims.

An embodiment of data processing environment 100 includes computer 110 and MDM server 120 interconnected over network 102. Network 102 can be, for example, a local area network (LAN), a telecommunications network, a wide area network (WAN) such as the Internet, or any combination of the three, and include wired, wireless, or fiber optic connections. In general, network 102 can be any combination of connections and protocols that will support communications between computer 110, MDM server 120 and any other computing device connected to network 102, in accordance with embodiments of the present invention.

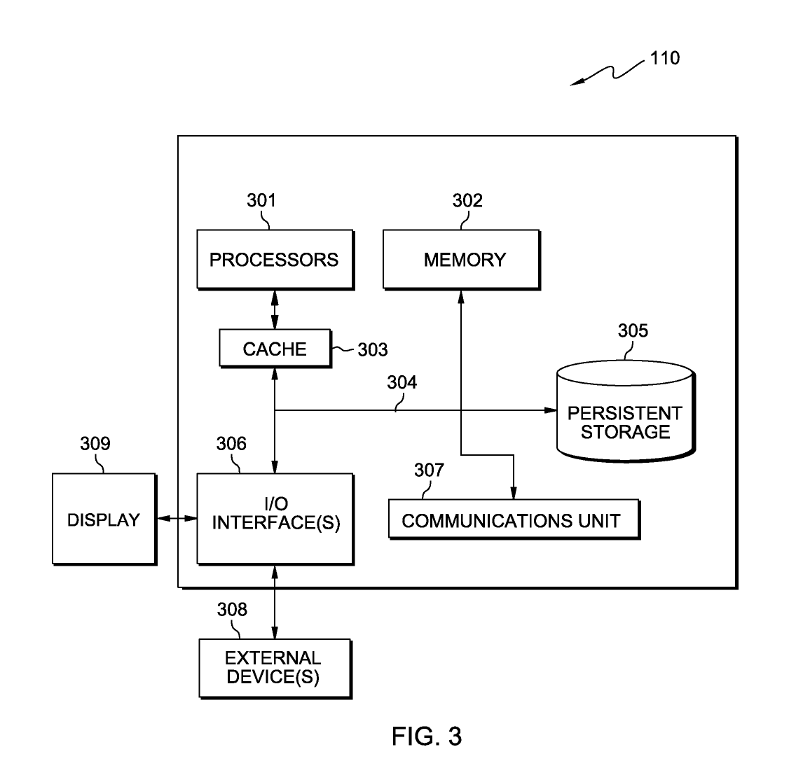

In example embodiments, computer 110 may be a laptop, tablet, or netbook personal computer (PC), a desktop computer, a personal digital assistant (PDA), a smart phone, or any programmable electronic device capable of communicating with any computing device within data processing environment 100. In certain embodiments, computer 110 collectively represents a computer system utilizing clustered computers and components (e.g., database server computers, application server computers, etc.) that act as a single pool of seamless resources when accessed by elements of data processing environment 100, such as in a cloud computing environment. In general, computer 110 is representative of any electronic device or combination of electronic devices capable of executing computer readable program instructions. Computer 110 may include components as depicted and described in further detail with respect to FIG. 3, in accordance with embodiments of the present invention.

In an embodiment, computer 110 includes Reference Data Management (RDM) hub 112, Knowledge Driven Consistency Enabling (KDCE) program 114, business glossary 116, and information repository 118. In an embodiment, RDM hub 112 is a program, application, or subprogram of a larger program that provides for stewardship, authoring, and management of reference data. In an embodiment, KDCE program 114 is a program, application, or subprogram of a larger program that is for managing data persistence between virtual MDM to physical MDM. In an embodiment, business glossary 116 stores enterprise wide business terms, term definitions, categorizations and asset references. In an embodiment, information repository 118 includes ontologies, glossaries, taxonomies, triples stores, dictionaries, etc., that may be maintained across a network of servers, flat files and/or databases, that include terms, definitions, categorizations, and references that are used to find indirect links and relationships between reference data. In an alternative embodiment, RDM hub 112, KDCE program 114, business glossary 116 and information repository 118 can be on separate computers (not shown) interconnected over network 102.

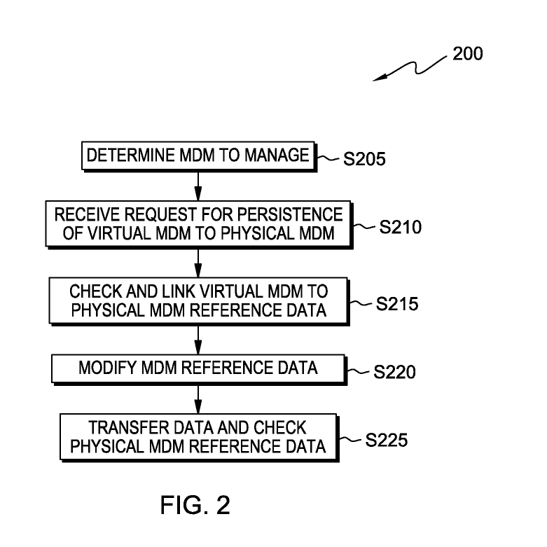

In an embodiment, RDM hub 112 allows a user to perform stewardship, authoring and management of reference data. A typical RDM hub implementation provides a data steward with the full range of reference data management capabilities, where he/she can take reference data sets through various lifecycle phases, create version of a base data set, create mappings between different data representations to an enterprise-wide standard, publish/distribute approved data sets, etc. Stewardship of reference data consists of at least the following tasks: importing or authoring reference data from source systems, managing changes to the reference data in an orderly fashion, and distributing the reference data to downstream systems. RDM hub 112 may also have role-based user interface with security and access control and provide one or more of the following functions: management of reference data sets and value, management of mappings and relationships between reference data sets, importing and exporting of reference data through both batch and user interface, versioning support for reference data sets and mappings, change process controlled through configurable lifecycle management and hierarchy management. RDM hub 112 may request for KDCE program 114 to perform any or all of the steps of FIG. 2 discussed below.

A user interface (not shown) is a program that provides an interface between a user and RDM hub 112. A user interface refers to the information (such as graphic, text, and sound) a program presents to a user and the control sequences the user employs to control the program. There are many types of user interfaces. In one embodiment, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computer, GUIs were introduced in reaction to the perceived steep learning curve of command-line interfaces, which required commands to be typed on the keyboard. The actions in GUIs are often performed through direct manipulation of the graphics elements.

In an embodiment, KDCE program 114 manages data persistence between virtual MDM 122 and physical MDM 124. KDCE program 114 determines a MDM to manage. In an embodiment, KDCE program 114 may manage multiple physical MDM and virtual MDM (i.e. a hybrid system). The physical MDM and virtual MDM may be located on the same computer or different computers interconnected over a network. KDCE program 114 receives a request for persistence of virtual MDM to physical MDM. In other words, a user, via RDM hub 112, requests to move data that is stored in a virtual MDM to a physical MDM. KDCE program 114 checks and links the virtual MDM to the physical MDM reference data. In other words, KDCE program 114 will determine if the physical MDM has any direct matches for data set terms that are in the virtual MDM. Next, KDCE program 114 will determine if virtual MDM has any data set terms that have matches in the business glossary that can link directly to data set terms in physical MDM. Finally, any remaining data set terms in virtual MDM are attempted to be indirectly linked to data set terms in physical MDM using business glossaries and information repositories. The indirect matches are approved or denied by a user via KDCE program 114 or RDM hub 112. KDCE program 114 then modifies the MDM reference data. In other words, KDCE program 114 modifies the reference data sets of virtual MDM to match with the reference data sets of physical MDM using the information determined previously. In addition, attributes for reference data sets may be modified as well. Finally, KDCE program 114 transfers the data from virtual MDM to physical MDM and determines if there are any issues in the data sets. KDCE program 114 may include a user interface substantially similar to the user interface of RDM hub 112, discussed previously.

In an embodiment, business glossary 116 is designed to help users understand business languages and the business meaning of information assets like databases, jobs, database tables and columns, and business intelligence reports. In addition to categories and terms, the business glossary also contains information about other assets such as database tables, jobs, and reports that are in MDM server 120. In an embodiment, business glossary 116 may be created, updated, or changed via RDM hub 112 or KDCE program 114 by a user. In an embodiment, business glossary 116 includes enterprise-specific terminology and its relationships to technical information assets. In other words, business glossary 116 includes enterprise wide business terms, term definitions, categorization, and asset references. In an embodiment, business glossary 116 is a simple classification hierarchy of terms where relationships have only one meaning. For example, an attribute for “Country Code” may indicate that “States A, B, and C” are part of “Country X.” Additionally, “Country X” is part of “Continent Y.”

In an embodiment, information repository 118 includes ontologies, glossaries, dictionaries, taxonomies, triple stores, etc., that may be maintained across a network of servers, flat files and/or databases, that include terms, definitions, categorizations, and references that are used to find indirect links and relationships between reference data. Information repository 118 can for a specific MDM server or a general information repository that covers multiple MDM servers or something available to the public. Information repository 118 contains information that is more expressive and less exact than business glossary 116. In other words, information repository includes information about terms that is more expressive and can represent different relationships. In an embodiment, information repository may be stored in a database (i.e. triple stores) or may be in the form of an .xml document representation. For example, “Person A” is father of “Person B.” Additionally, “Person B” has “Pet X.” And also, “Person B” is mother of “Person C.” This example shows different relationships through an ontology and associated triples (facts based on the ontology).

In example embodiments, MDM server 120 may be a laptop, tablet, or netbook personal computer (PC), a desktop computer, a personal digital assistant (PDA), a smart phone, or any programmable electronic device capable of communicating with any computing device within data processing environment 100. In certain embodiments, MDM server 120 collectively represents a computer system utilizing clustered computers and components (e.g., database server computers, application server computers, etc.) that act as a single pool of seamless resources when accessed by elements of data processing environment 100, such as in a cloud computing environment. In general, MDM server 120 is representative of any electronic device or combination of electronic devices capable of executing computer readable program instructions. MDM server 120 may include components as depicted and described in further detail with respect to FIG. 3, in accordance with embodiments of the present invention.

In an embodiment, MDM server 120 includes virtual MDM 122 and physical MDM 124. MDM server is substantially similar to computer 110. In an embodiment, virtual MDM 122 and physical MDM 124 may be found on the same computer (i.e., MDM server 120). In an alternative embodiment, virtual MDM 122 and physical MDM 124 may be found on computer 110 or separate computers (not shown) interconnected via network 102.

In an embodiment, virtual MDM 122 is a virtual style of MDM implementation where master data is managed such that it remains fragmented across multiple source systems (not shown) in a distributed manner with a central indexing service. In other words, the master data for virtual MDM 122 is stored or created in a distributed arrangement across multiple source systems (not shown) and remains fragmented across those source systems (not shown). Virtual MDM 122 is a central indexing service for the distributed data. Virtual MDM 122 may be connected to RDM hub 112 to allow a user to access, view, modify, change, update, etc. information found in Virtual MDM 122. Virtual MDM 122 provides a trusted view of the linked and matched information to the user on demand via RDM hub 112. A single view of the master data information of Virtual MDM 122 is not persisted in Virtual MDM 122 and modifications to the master data are made on the source systems (not shown).

In an embodiment, physical MDM 124 is a physical style of MDM implementation where master data is managed such that it is stored or created in a centralized system from where it is accessed. In other words, the master data for Physical MDM 124 is created on MDM server 120, remains on MDM server 120, and is accessed via MDM server 120. Physical MDM 124 is a central indexing service for the centralized data. Physical MDM 124 may be connected to RDM hub 112 to allow a user to access, view, modify, change, update, etc. information found in physical MDM 124. All information relevant to providing a single view of the master data is stored in Physical MDM 124. In other words, after all the matching and collapsing of records across the source system, only a single view of the master data remains in the repository. Physical MDM 124 then becomes the system of record for centrally managing the master data.

FIG. 2 is a flowchart of workflow 200 depicting operational steps for managing data persistence between virtual MDM to physical MDM, in accordance with an embodiment of the present invention. In one embodiment, the steps of the workflow are performed by KDCE program 114. Alternatively, steps of the workflow can be performed by any other program while working with KDCE program 114 (e.g. RDM Hub 112). In an embodiment, KDCE program 114 may invoke workflow 200 upon receiving a request for persistence of data from virtual MDM 122 to physical MDM 124. A user, via the user interface discussed previously, may change, edit or modify any steps of workflow 200.

KDCE program 114 determines MDM to manage (step S205). In an embodiment, a user, via the user interface of RDM Hub 112 may indicate to KDCE program 114 to manage virtual MDM 122 and physical MDM 124. In an alternative embodiment, a user, via the user interface of KDCE program 114 may indicate to KDCE program 114 to manage virtual MDM 122 and physical MDM 124. In yet another alternative embodiment, a user, via another program (not shown), may indicate to KDCE program 114 they would like to manage virtual MDM 122 and physical MDM 124. Alternatively, KDCE program 114 may manage multiple virtual MDM and physical MDM (not shown) at the same time. Additionally, the user, in any embodiment, may indicate at least one business glossary (i.e., business glossary 116) and at least one information repository (i.e., information repository 118) that is associated with either the virtual MDM 122 or physical MDM 124. The user may be a steward, data manager, administrator, information architect, or the like.

KDCE program 114 receives a request for data persistence of data of virtual MDM to physical MDM (step S210). In an embodiment, a user can make a request to KDCE program 114 via RDM hub 112, via KDCE program 114, or any other program (not shown) to move data from virtual MDM 122 to physical MDM 124. In an embodiment, virtual MDM 122 and physical MDM 124 are on the same device (i.e., MDM server 120), as shown. In an alternative embodiment, virtual MDM 122 and physical MDM 124 may be on separate devices.

KDCE program 114 checks and links virtual MDM reference data to physical MDM reference data (step S215). In an embodiment, KDCE program 114 checks the reference data sets of virtual MDM 122 and finds reference data that is the same as reference data of physical MDM 124 and then will link these matching reference data sets. Linking a reference data set of virtual MDM to a reference data set of physical MDM 124 consists of indicating to the program that the reference data set of virtual MDM 122 will be moved to the linked reference data set of physical MDM 124 when the data persistence occurs. KDCE program 114 checks and links the category of the reference data sets. For example, KDCE program 114 checks and links the category of the reference data set (i.e., “Country”) and not individual data in the reference data set (i.e., “USA, Brazil, Germany, etc.). First, KDCE program 114 checks to see if physical MDM 124 has any reference data sets that are identical to virtual MDM 122 using business glossary 116. Second, KDCE program 114 checks to see if the remaining reference data sets of virtual MDM 122 that did not have identical data sets in physical MDM 124 have any indirect matches in physical MDM 124 using business glossary 116 and information repository 118.

In an embodiment, KDCE program 114 determines if physical MDM 124 has any reference data sets that are identical to virtual MDM 122 using business glossary 116. For example, physical MDM 124 may have a reference data set termed “Country Code” and KDCE program 114 will recognize a reference data set termed “Country Code” in virtual MDM 122 and link the reference data sets. In another example, physical MDM 124 may have a reference data set termed “Country Code” and KDCE program 114 will recognize a reference data set termed “Nation Code” in virtual MDM 122. KDCE program 114 checks virtual MDM 122 and determines that virtual MDM 122 does not have a reference data set termed “Country Code.” However, KDCE program 114 checks business glossary 116 and determines that the reference data set term “Country Code” can also be called “Nation Code.” KDCE program 114 will link the reference data set termed “Country Code” in physical MDM 124 to the reference data set termed “Nation Code” in virtual MDM 122.

In an embodiment, for the remaining reference data sets in virtual MDM 122 that have not been linked to reference data sets in physical MDM 124, KDCE program 114 checks business glossary 116 and information repository for indirect matches. In other words, KDCE program 114 determines any reference data sets found in virtual MDM 122 that have not been linked to a reference data set in physical MDM 124. Next, for each reference data term in virtual MDM 122 that has not been linked to a reference data set term in physical MDM 124, KDCE program 114 searches both business glossary 116 and information repository 118 to find links between the reference data set terms in virtual MDM 122 that have not been linked to a reference data set terms in physical MDM 124. In an embodiment, KDCE program 114 can look to the parent term or category (i.e., the reference data set “eye color” may have a parent term or category of “physical characteristics”) of the reference data set terms in order to find closely related reference data sets. In an embodiment, if KDCE program 114 determines there are reference data sets in physical MDM 124 that are indirect matches to reference data sets in virtual MDM 122, they are suggested to the user, via the user interface of RDM hub 112, and the user has the option to determine if the reference data sets are matching and if they are then the user can indicate that they be mapped to each other. In an embodiment, KDCE program 114 can suggest more than one reference data set of physical MDM 124 that is an indirect match to a reference data set of virtual MDM 122 to the user and the user can indicate to KDCE program 114 if any of the reference data sets should be linked.

For example, virtual MDM 122 may have a reference set termed “Origin Country” that has not been linked to a reference data set in physical MDM 124. Using business glossary 116 and information repository 118, KDCE program 114 determines two potential reference data set terms in physical MDM 124, “Country Code” and “Origin of Document,” that could be mapped to “Origin Country.” Business glossary 116 and/or the information repository 118 have a category hierarchy or a term relationship structure. In an embodiment, some of these terms are linked to reference data sets across different systems. The information in the information repository 118 is linked to the underlying reference data sets. KDCE program 114 navigates the structures of terms and relationship in business glossary 116 and information repository 118 and determines potential relationships across different terms that represent reference data sets. In an embodiment, a semantic search algorithm (based on subject-predicate-object patterns) can discover this indirect potential matching between reference data sets. KDCE program 114 then presents these terms to a user and the user can determine if they are proper links. The user may determine that the term “Origin Country” can be properly mapped to “Country Code” and KDCE program 114 notes this from the user's input via RDM hub 112. Additionally, the user, for any reference data sets of virtual MDM 122 that are not mapped to reference data sets of physical MDM 124 determines appropriate mappings so that all reference data sets of virtual MDM 122 have corresponding reference data sets of physical MDM 124.

KDCE program 114 modifies MDM reference data (step S220). In an embodiment, KDCE program 114 modifies any reference data sets of virtual MDM 122 that have been mapped to reference data sets in physical MDM 124, as determined in the previous step. Additionally, attributes or data for each reference data set are modified as well. For example, if a reference data set “Nation Code” of virtual MDM 122 is mapped to a reference data set “Country Code” of physical MDM 124, then KDCE program 114 modifies the reference data set of virtual MDM 122 from “Nation Code” to “Country Code.” Additionally, KDCE program 114, using business glossary 116, will change each of the attributes of the data set. For example, if for “Person 1” found in reference data set, “Nation Code,” has an attribute “US”, KDCE program 114, using business glossary 116, will determine that, in physical MDM 124, the reference data set “Country Code” uses “USA” instead of “US.” KDCE program 114 will change the attribute “US” for “Person 1” to “USA.”

KDCE program 114 transfers data and checks physical MDM reference data (step S225). In other words, KDCE program 114 completes the data persistence between virtual MDM 122 and physical MDM 124. Additionally, after the data persistence has occurred, KDCE program 114 determines that all data that is found in reference data sets of physical MDM 124 is accurate. For example, in the reference data set is “Gender Code” the options for attributes in the “Gender Code” dataset are (Male, M; Female, F; Unknown, U). If KDCE program 114 determines that for “Person 1” that their attribute for the “Gender Code” data set, KDCE program 114 notifies the user of the issue via RDM hub 112. This allows the user to change the data or request additional data from another user.

FIG. 3 depicts computer 300 which is representative of computer 110, which includes KDCE program 114, and MDM server 120. Computer 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method of managing data persistence between a virtual master data management (MDM) system and a physical MDM system, the method comprising the steps of:
receiving, by one or more computer processors, a request to move a reference data set in a virtual MDM to a physical MDM;
determining, by one or more computer processors, for the reference data set in the virtual MDM if there is an at least partially matching reference data set in the physical MDM; and
performing, by one or more computer processors, the request received, wherein the request is performed for the reference data set of the virtual MDM.

2. The method of claim 1, wherein determining for the reference data set in the virtual MDM if there is an at least partially matching reference data set in the physical MDM comprises:
determining, by one or more computer processors, for the reference data set of the virtual MDM if there is an identically matching reference data set in the physical MDM; and
responsive to determining for the reference data set of the virtual MDM that there is not an identically matching reference data set in the physical MDM, determining, by one or more computer processors, for the reference data set of the virtual MDM at least one reference data set in the physical MDM that is at least partially matching using an information repository.

3. The method of claim 2, further comprising:
receiving, for the at least one reference data set in the physical MDM that is at least partially matching, an indication from a user whether any of the at least one reference data set in the physical MDM is a matching reference data set of the reference data set of the virtual MDM.

4. The method of claim 1, further comprising:
responsive to determining an at least partially matching reference data set in the physical MDM, modifying, by one or more computer processors, the reference data set of the virtual MDM that has the at least partially matching reference data set in the physical MDM.

5. The method of claim 4, further comprising:
determining, by one or more computer processors, if the reference data set in the virtual MDM, that has been modified to the at least partially matching reference data set of the physical MDM, includes terms of the at least partially matching reference data set in the physical MDM; and
responsive to determining that the reference data set that has been modified does not include terms of the at least partially matching reference data set in the physical MDM, notifying, by one or computer processors, a user of the reference data set that has been modified that the reference data set that has been modified does not include terms of the at least partially matching reference data set in the physical MDM.

6. The method of claim 1, wherein the step of determining for the reference data set in the virtual MDM if there is an at least partially matching reference data set in the physical MDM comprise:
receiving an indication from a user, wherein the indication includes the reference data set in the physical MDM that is at least partially matching the reference data set of the virtual MDM.

7. The method of claim 2, wherein the information repository comprises at least one of the following: an ontology, a glossary, a taxonomy, a triple store, and a dictionary.

8. A computer program product for managing data persistence between a virtual master data management (MDM) system and a physical MDM system, the computer program product comprising:
one or more computer readable storage media; and
program instructions stored on the one or more computer readable storage media, the program instructions comprising:
program instructions to receive a request to move a reference data set in a virtual MDM to a physical MDM;
program instructions to determine for the reference data set in the virtual MDM if there is an at least partially matching reference data set in the physical MDM; and
program instructions to perform the request received, wherein the request is performed for the reference data set of the virtual MDM.

9. The computer program product of claim 8, wherein the program instructions to determine for the reference data set in the virtual MDM if there is an at least partially reference data set in the physical MDM comprises:
program instructions to determine for the reference data set of the virtual MDM if there is an identically matching reference data set in the physical MDM; and
program instructions, responsive to determining for the reference data set of the virtual MDM that there is not an identically matching reference data set in the physical MDM, to determine for the reference data set of the virtual MDM at least one reference data set in the physical MDM that is at least partially matching using an information repository.

10. The computer program product of claim 9, further comprising program instructions, stored on the one or more computer readable storage media, to:
receive for the at least one reference data set in the physical MDM that is at least partially matching, an indication from a user whether any of the at least one reference data set in the physical MDM is a matching reference data set of the reference data set of the virtual MDM.

11. The computer program product of claim 8, further comprising program instructions, stored on the one or more computer readable storage media, to:
responsive to determining that the reference data set that has been modified does not include terms of the at least partially matching reference data set in the physical MDM, notify a user of the reference data set that has been modified that the reference data set that has been modified does not include terms of the at least partially matching reference data set in the physical MDM.

12. The computer program product of claim 11, further comprising program instructions, stored on the one or more computer readable storage media, to:
determine if the reference data set in the virtual MDM, that has been modified to the at least partially matching reference data set of the physical MDM, includes terms of the at least partially matching reference data set in the physical MDM; and
responsive to determining that the reference data set that has been modified does not include terms of the at least partially matching reference data set in the physical MDM, notify a user of the reference data set that has been modified that the reference data set that has been modified does not include terms of the at least partially matching reference data set in the physical MDM.

13. The computer program product of claim 8, wherein the program instructions to determine for the reference data set in the virtual MDM if there is an at least partially matching reference data set in the physical MDM comprise:
program instructions to receive an indication from a user, wherein the indication includes the reference data set in the physical MDM that is at least partially matching the reference data set of the virtual MDM.

14. The computer program product of claim 9, wherein the information repository comprises at least one of the following: an ontology, a glossary, a taxonomy, a triple store, and a dictionary.

15. A computer system for managing data persistence between a virtual master data management (MDM) system and a physical MDM system, the computer system comprising:
one or more computer processors;
one or more computer readable storage media; and
program instructions stored on the one or more computer readable storage media for execution by at least one of the one or more computer processors, the program instructions comprising:
program instructions to receive a request to move a reference data set in a virtual MDM to a physical MDM;
program instructions to determine for the reference data set in the virtual MDM if there is an at least partially matching reference data set in the physical MDM; and
program instructions to perform the request received, wherein the request is performed for the reference data set of the virtual MDM.

16. The computer system of claim 15, wherein the program instructions to determine for the reference data set in the virtual MDM if there is an at least partially reference data set in the physical MDM comprises:
program instructions to determine for the reference data set of the virtual MDM if there is an identically matching reference data set in the physical MDM; and
program instructions, responsive to determining for the reference data set of the virtual MDM that there is not an identically matching reference data set in the physical MDM, to determine for the reference data set of the virtual MDM at least one reference data set in the physical MDM that is at least partially matching using an information repository.

17. The computer system of claim 16, further comprising program instructions, stored on the one or more computer readable storage media for execution by at least one of the one or more computer processors, to:
receive for the at least one reference data set in the physical MDM that is at least partially matching, an indication from a user whether any of the at least one reference data set in the physical MDM is a matching reference data set of the reference data set of the virtual MDM.

18. The computer system of claim 15, further comprising program instructions, stored on the one or more computer readable storage media for execution by at least one of the one or more computer processors, to:
responsive to determining that the reference data set that has been modified does not include terms of the at least partially matching reference data set in the physical MDM, notify a user of the reference data set that has been modified that the reference data set that has been modified does not include terms of the at least partially matching reference data set in the physical MDM.

19. The computer system of claim 18, further comprising program instructions, stored on the one or more computer readable storage media for execution by at least one of the one or more computer processors, to:
determine if the reference data set in the virtual MDM, that has been modified to the at least partially matching reference data set of the physical MDM, includes terms of the at least partially matching reference data set in the physical MDM; and
responsive to determining that the reference data set that has been modified does not include terms of the at least partially matching reference data set in the physical MDM, notify a user of the reference data set that has been modified that the reference data set that has been modified does not include terms of the at least partially matching reference data set in the physical MDM.

20. The computer system of claim 15, wherein the program instructions to determine for the reference data set in the virtual MDM if there is an at least partially matching reference data set in the physical MDM comprise:
program instructions to receive an indication from a user, wherein the indication includes the reference data set in the physical MDM that is at least partially matching the reference data set of the virtual MDM.
